(19) United States
(12) Patent Application Publication
(10) Pub. No.: US 2009/0214729 A1
(43) Pub. Date: Aug. 27, 2009

(54) LOW CALORIC DENSITY AERATED CONFECTIONS AND METHODS OF PREPARATION

(75) Inventor: JUSTIN SHIMEK, San Ramon, CA (US)

Correspondence Address: GENERAL MILLS, INC., P.O. BOX 1113, MINNEAPOLIS, MN, 55440, US

(73) Assignee: General Mills IP Holdings II, LLC.

(21) Appl. No.: 12/260,730

(22) Filed: Oct. 29, 2008

Related U.S. Application Data
(60) Provisional application No. 61/031,383, filed on Feb. 26, 2008.

(51) Int. Cl. A23P 1/16; A23L 1/48

(52) U.S. Cl. 426/312; 426/561

(57) ABSTRACT

Disclosed are low caloric density aerated grained confections. The confections essentially comprise tagatose as their primary carbohydrate or principle ingredient, about 0.5-30% of a structuring agent and moisture. Up to 60% of the tagatose can be substituted with nutritive carbohydrate ingredients, fiber and whipping or foaming agents or combinations thereof. Optionally, additional nutritional fortifying ingredients and conventional optional ingredients such as colors and flavors can be added. The confection compositions have densities of 0.10-1 g/cc. The products are additionally characterized by a size count of 0.2-6/g. Preparation methods for the pieces are also disclosed. The confectionery food products find particular suitability for use as ingredients for reduced calorie children's RTE cereals.

### CROSS-REFERENCE TO RELATED APPLICATIONS

This application claims the benefit of priority under 35 U.S.C. 119(e)(1) of a provisional patent application, Ser. No. 61/031,383, filed Feb. 26, 2008, which is incorporated herein by reference in its entity.

### FIELD OF THE INVENTION

The present invention is directed generally to food products and to their methods of preparation. In particular, the present invention is directed to improved aerated confectionery products such as dried marshmallows that have a low caloric density and to processes for making low caloric density aerated, confectionery products.

### BACKGROUND OF THE INVENTION

Aerated confectionery products are popular food items. Some products are fabricated from aerated confection compositions that comprise a fat constituent while others are substantially free of such fat constituents. An illustrative fat free aerated confection is the common marshmallow. Such marshmallow products are familiar in both larger and smaller sizes.

It is well known that such marshmallows when fresh are soft and pliable but will stale by losing moisture and become harder. Indeed, purposefully pre-dried aerated confections are also well known. These products, particularly in smaller or bite sizes, are commonly added to certain popular Ready-To-Eat (“RTE”) breakfast cereals, particularly those that appeal to children. Due to their small size (i.e., having a number count of about 3 to 6/g.), these dried aerated confectionery marshmallow products are sometimes colloquially referred to as “Marshmallow bits” or “marbits”. The marbits must be pre-dried prior to admixture with the RTE cereal in order to reduce unwanted moisture migration from the marbit to the cereal and thus to forestall the multiple problems resulting therefrom. These dried marshmallow pieces exhibit desirable crisp, frangible eating qualities. Generally, marbits are desirably a grained confection. Thus, such dried confections are crunchy rather than tough or chewy.

While there are many types of sugar containing marshmallow products on the market, their methods of preparation generally fall into two main process groups: extruded marshmallow and deposited marshmallow. In both types, a sugar syrup, a structuring agent, and a whipping agent are the main ingredients. Often, gelatin is used as both the whipping agent to form an aerated foam as well as the structuring agent for setting the foam. Typically, the sugar syrup is heated to reduce moisture and is thereafter cooled down, and then combined with the gelatin solution to form a slurry. That slurry is then aerated to form a foam. Optionally, colors and flavors are added to the foam immediately after aeration although in certain embodiments these adjuvants are added to the syrup prior to aerating. The particular marshmallow product may be formed into its final shape by an extrusion process. That is, after aeration, the foam is extruded through a die to form a rope. The die imparts the desired peripheral shape to the extrudate rope. The rope is allowed to rest briefly to set, and it may be dusted or enrobed with starch before being cut into desired sizes. For dried marshmallows, the process can additionally include one or more drying steps. (See, for example U.S. Pat. No. 4,785,551 issued Nov. 2, 1988 to W. J. Meyer entitled “Method of Drying Confection Pieces”).

While marshmallows of a single color are most common, marshmallows having two or even a plurality of colors (collectively herein, “multi-colored”) are also known (see, for example, D376,039 issued Dec. 3, 1996 entitled “Food Product”, showing a two color marbit design) as well as methods for their preparation. (See, for example, U.S. Pat. No. 4,925,380 issued Oct. 20, 1986 entitled “Multicolor Confection Extrusion System and U.S. Pat. No. 5,019,404 issued Feb. 28, 1990 entitled “Multicolor Confection Extrusion System”). Both the '404 and '380 patent each well describe the difficulties and sensitivities of such foam product preparation. The conventional processes for making multi-colored marshmallows teach to divide the aerated foam into a plurality of sub-streams, to admix a desired colorant to each sub-stream, and then extrude these colored sub-streams in substantially equal portions into a single rope or multiplicity of such ropes. Alternatively, a cooked sugar syrup or slurry is divided into individual portions or sub-streams to each of which are added distinctive colors and/or flavors that are individually aerated. The separate foam sub-streams or portions are then recombined to fabricate more complex product designs.

Similarly, marshmallows composed of a single formulation are most common, however marshmallows composed of two or more formulations are also known (see, for example U.S. Pat. No. 6,207,216 issued Mar. 27, 2001 entitled “Quickly Dissolving Aerated Confection and Method of Preparation”). The use of novel protein containing marshmallow formulations capable of dissolving at different rates upon contact with liquid is well described in '216. The use of novel non-protein containing marshmallow formulations also capable of dissolving at different rates upon contact with liquid are described herein. Marshmallows containing such formulations change their appearance upon exposure to liquid when the faster dissolving portion dissolves, leaving behind the slower dissolving portion and its residual shape.

Since marshmallow pieces are so drastically different in their formulation and method of making from the cereal pieces they often accompany in commercially marketed cereal products, they can be used as a vehicle to carry nutritional supplements or other beneficial ingredients not easily incorporated into cereal pieces. Such nutritional components include biologically active components, fiber, micro-nutrients, minerals and mixtures thereof. Marshmallow bits can also serve as carriers of useful drugs and pharmacological agents. Such nutritionally fortified marshmallow pieces are also known (see, for example U.S. Pat. No. 6,432,460 issued Aug. 13, 2002 entitled “Food Product and Method of Preparation”, and U.S. Pat. No. 6,793,953 issued Sep. 21, 2004 entitled “Food Product and Method of Preparation”). Marshmallows described in '460 produced by the process described in '953 can contain calcium, an important mineral for bone health, at fortifying levels without significantly altering the taste as compared to an unfortified marshmallow.

As previously described marbits can be admixed with loose ready-to-eat cereal pieces, such cereal blends can comprise about 10%-40% marbits. The RTE cereal pieces to which the marbits are added are often themselves sugar coated to provide not only desirable sweetness but also to enhance their crunchy texture. Since marbits can contain 90% or more sugar, the combined RTE cereal blend can be quite high in calories. Some parents believe that consumption of high calorie foods by their children is not good and even that such consumption in combination with a sedentary lifestyle can result in obesity. Some concerned parents desire RTE cereals that not only their children enjoy but also those that are lower in calorie content. Thus, it would be desirable to provide a low caloric density dried grained aerated confection suitable for addition as a component to an RTE cereal.

While multicolored and appearance changing marshmallow pieces have enhanced consumer appeal particularly for children's products, such products are perceived to be undesirable by some from a nutritional standpoint due to their caloric density. Accordingly, there is a continuing need for new confectionery products having additional novel aspects beyond appearance and nutrition supplementation; namely marshmallow and dried aerated confections characterized in part by reduced caloric density.

Surprisingly, the above needs can be met and improved low caloric density dried grained aerated confections provided. The present improved aerated confections comprise tagatose as their principle ingredient.

The present invention additionally provides methods of preparing such improved low caloric density dried aerated confections. In one variation, low caloric density aerated confections are colored and flavored. A combination of two or more colors or flavors may be blended into a single grained confectionary piece or it can contain separately colored and flavored regions. In another variation, composite low caloric density dried aerated confections are prepared comprising either a protein containing or hypoallergenic non-protein containing quickly dissolving confection portion and a slowly dissolving confection portion. Such confections can be prepared by substituting the present marshmallow compositions for those of the '216 patent's methods or those described herein. In still another variation, low caloric density aerated confections can be fortified with nutritional components in the manner described in '460 and '953.

### BRIEF SUMMARY OF THE INVENTION

In its product aspect, the present invention resides in dried grained low caloric density aerated confectionery compositions and products prepared therefrom especially suitable for admixture with an RTE cereal base. The low caloric density aerated confections compositions comprise:
about 88-97% (dry weight basis) tagatose; and
about 3-12% (dry weight basis) of a structuring component.

Up to about 65% of the tagatose can be substituted for nutritive carbohydrate components, fiber, whipping or foaming agents and combinations thereof. The composition can additionally contain various conventional optional ingredients.

The confection compositions have densities of 0.10-1 g/cc.

The products are additionally characterized by a size count of 1-6/g.

These products can have a body of one color or the body can comprise a plurality of disparately colored phases. In another product aspect, low caloric density dried grained aerated confections can be formulated to dissolve quickly in cold water or milk. In still another product aspect, low caloric density dried grained aerated confections can be formulated to supply nutritional ingredients.

In its principle method aspect, the present invention provides methods of preparing such low caloric confection compositions. The composition methods of preparation comprise the steps of:
A. Preparing a slurry comprising:
   about 35%-97% (dry weight basis) tagatose;
   35% (dry weight basis) or less nutritive carbohydrate components;
   25% (dry weight basis) or less fiber;
   about 3%-12% (dry weight basis) structuring component;
   5% or less of a whipping or foaming agent(s); and
   about 10%-20% moisture
   comprising the substeps of:
1. admixing the tagatose, nutritive carbohydrate components (if present), fiber (if present), optional nutritional fortifying component (if present) and water;
2. heating the mixture to dissolve the ingredients to about 75-100° C. (about 170-212° F.) to form a hot clear syrup;
3. hydrating the structuring component to form a hydrated structuring component;
4. cooling the hot clear liquid to a temperature of 72° C. (162° F.) or cooler to form a cooled clear syrup;
5. admixing the hydrated structuring component and optionally the whipping or foaming agent (if present) with the cooled syrup to form a slurry;
B. Aerating the slurry with nitrogen to form a hot plastic aerated marshmallow foam having a moisture content of about 10% to about 15%;
C. Forming the foam into pieces; and,
D. Drying the pieces to a moisture content of 1%-6% to form low caloric density dried marshmallow pieces.

In another method aspect, the present invention provides methods for preparing composite products comprising a first portion of a low caloric density aerated confection, and a second portion of a low caloric density aerated confection comprising the steps of:
A. Providing a first steam of a first low caloric density aerated confection composition having one portion fabricated from a quickly dissolving low caloric density aerated confection composition having:
   a moisture content of about 8% to about 25%;
   a density of about 0.1 to about 1.0 g/cc;
   a temperature of about 21-83° C. (70-180° F.); and,
B. Providing a second steam of a second low caloric density aerated confection composition fabricated from a slowly dissolving low caloric density aerated confection composition having:
   a moisture content of about 8% to about 25%;
   a density of about 0.1 to about 1.0 g/cc;
   a temperature of about 49-83° C. (120-180° F.); and,
C. Coextruding the first stream and second stream under pressure in an extruder without substantial intermingling of the extrusion stream to form a combined stream;
D. Severing the combined stream into pieces;
E. Drying the low caloric density aerated confection pieces to a moisture content of about 1%-6% to form low caloric density dried aerated confections having a first quickly dissolving portion and a second slowly dissolving portion.

In another method aspect, the present invention provides methods for preparing nutritionally fortified low caloric density grained aerated confection comprising the steps of:
A. Providing a cooled low caloric density slurry confectionery blend comprising:
   about 35-97% (dry weight basis) tagatose;
   35% (dry weight basis) or less of a nutritive carbohydrate component;
   25% (dry weight basis) or less fiber;
   about 3-12% of a structuring agent;
   5% or less of a whipping or foaming agent;
   and, about 1-30% moisture;
B. Seeding the low caloric density liquid slurry confection blend with about 0.01%-45% of a dry particulate nutritional fortification component having a particle size distribution such that 90% have a particle size of less than 400 microns, to form a seeded liquid confection blend;
C. Aerating the seeded low caloric density liquid confection blend to form a low caloric density aerated confection plastic foam having a density of about 0.1-1.0 g/cc and a temperature of about 32-82° C. (90-180° F.);
D. Extruding the aerated foam at a temperature of about 32-82° C. (90-180° F.) to form a low caloric density aerated confection extrudate;
E. Cooling the extrudate to set the confection to form a set low caloric density aerated confection extrudate; and,
F. Forming the set low caloric aerated confection extrudate into pieces.

### DETAILED DESCRIPTION OF THE INVENTION

The present invention provides low caloric density dried aerated confections compositions and products prepared therefrom and to methods for preparing such aerated confections products. Each of the product ingredients and product features and steps of the present methods are described in detail below.

Throughout the specification and claims, percentages are by weight and temperatures in degrees Centigrade unless otherwise indicated. Each of the referenced patents are incorporated herein by reference.

The present invention provides low caloric density improved aerated confectionery products that mimic their full sugar containing aerated confectionary counterpart products in taste, appearance and texture. The present confectionery products find particular suitability for use as added components to children's ready-to-eat breakfast cereals or as ingredients to shelf stable food products such as granola bars or additives to such products as hot cocoa mixes.

Traditional marbit products generally comprise about 90% or more sugar that provides 4 kilocalories per gram. By “sugar” as meant herein are common nutritive saccharidic sweetening agents and include not only disaccharides such as sucrose but also monosaccharides as glucose, dextrose and fructose as well as oligosaccharides found in corn syrup, corn syrup solids, and maltodextrin. “Oligosaccharides” as used herein describes a molecule containing two to twenty sugar units joined by glycosidic bonds. The soluble fiber, inulin, is an example of an oligosaccharide discussed herein.

“Low caloric density” as used herein is meant that the aerated confectionary products have a 25% or more reduction in calories as compared to traditional aerated confectionary products.

By “aerated confection product” is meant an aerated solid confectionery food product in solid form having a density in the range of from about 0.10 to about 1 g/cc.

The low caloric density aerated confectionery compositions essentially comprise 1) tagatose, 2) a structuring component, and 3) residual moisture. Optional ingredients include 1) a saccharide component(s), 2) fiber, 3) a whipping or foaming agent(s), and 4) supplemental ingredients.

The low caloric density aerated confectionery composition products are fabricated from compositions that essentially comprise about 88-97% tagatose as the principle ingredient and about 3-12% of a structuring agent. Up to 60% of the tagatose can be substituted for nutritive carbohydrate ingredients, fiber or combinations thereof. Most preferably, the low caloric density aerated confections lack the nutritive carbohydrate component because of the inherent calories these ingredients provide.

The primary carbohydrate ingredient in low caloric density aerated confections is tagatose. Traditional marbits contain about 50 to about 95% of a saccharide component as the principle ingredient. Tagatose is the preferred primary carbohydrate or principle ingredient for low caloric density aerated confections. Tagatose is preferred for use herein due to its low caloric value of 1.5 kilocalories per gram, low glycemic response and because it has been shown not to promote dental carries.

Tagatose is well known and the skilled artisan will have no difficulty in selecting useful commercially available tagatose ingredients from commercial suppliers. Tagatose is a stereoisomer of D-fructose, meaning the tagatose isomer is composed of the same atoms with the same connectivity as D-fructose, but their arrangements are unique. Like most stereoisomers, the arrangement of the individual atoms in tagatose and D-fructose create differences in the way they are metabolized by the body. Tagatose has 1.5 kilocalories per gram whereas D-fructose has 4 kilocalories per gram. Like D-fructose, however tagatose is considered a carbohydrate sugar. Tagatose is a white crystalline powder, that is 92% as sweet as sucrose.

The low caloric density confections essentially further include about 0.5-30%, preferably about 1-6% and most preferably about 2.5 weight percent of a foam structuring or gelling component. Suitable structuring components include gelatin; hydrophilic colloids such as pectin; modified starches; gums such as guar and carrageenan; and, mixtures thereof. For products to be marketed in North America, the preferred structuring agent is gelatin. The gelatin can be derived from bovine, porcine, or piscine (fish) sources or can be of mixtures thereof. Preferred for use herein is high Bloom strength gelatin, e.g., 200 Bloom strength or 250 Bloom strength. In another protein free embodiment, the structuring agent is a combination of carrageenan and guar gums.

Low caloric density aerated confections can optionally contain nutritive carbohydrate component. Such nutritive carbohydrate ingredients can replace up to 60% of the tagatose contained in low caloric density aerated confections. Nutritive carbohydrate ingredients include both sweeteners and starches.

Nutritive carbohydrate sweetening ingredients include those such as monosaccharides such as dextrose (e.g., anhydrous, monohydrate or dextrose syrup) fructose, mannose, and galactose and disaccharide sugars such as sucrose, maltose, trehalose, and lactose, as well as hydrolyzed starch syrups such as corn syrup which include dextrin, maltose and dextrose, invert sugar syrups which include levulose and dextrose and/or converted fructose or glucose syrups. The nutritive carbohydrate component as described herein is most commonly provided by such nutritive carbohydrate sweetening ingredients as extra fine ground sugar and corn syrup. In other variations however, all or a portion of the nutritive carbohydrate component can be supplied by impure or flavored saccharidic ingredients such as fruit juices, purees, honey nectars, concentrated fruit juices, fruit flavors and mixtures thereof. The nutritive carbohydrate component can also include a polysaccharide component or portion such as about 1-15% cornstarch. The cornstarch ingredient typically is added as part of a topical cornstarch addition to control stickiness. Some quantity of cornstarch is incorporated into the surface of the marbit as a consequence of this usage of cornstarch. In preferred embodiments, the nutritive carbohydrate component of choice is sucrose.

To maintain the desired calorie content, taste, texture and handling properties of low caloric density aerated confections it is important to avoid replacing more than 60% of the tagatose with a nutritive carbohydrate component. In cases where tagatose is combined with a nutritive carbohydrate component it is important that tagatose alone or the combination of tagatose and a nutritive carbohydrate component maintain a superior proportion to any optionally added fiber. One skilled in the art of product development will have little difficulty selecting a fiber ingredient for addition to low caloric density aerated confections. Two fiber ingredients particularly suited for use in low caloric density marbits are inulin and polydextrose.

The oligosaccharide inulin also described in '460 contributes no added calories to low caloric density aerated confections yet provides soluble fiber and can replace minor amounts of the tagatose without significantly altering the taste, texture and appearance of low caloric density aerated confections. The same is true for polydextrose. Polydextrose is a synthesized polymer made from dextrose and contains some bound sorbitol and citric acid. Largely due to its physical characteristics and its low digestibility by humans it is also considered a soluble fiber. Both inulin and polydextrose are easily obtained commercially and are well known to those individuals skilled in the art of food formulations. Inulin is preferred to polydextrose as a fiber ingredient in low caloric density aerated confections because of its perception that it is both a natural ingredient and less likely to cause gastrointestinal distress upon consumption.

Tagatose provides sweetness and structure to low caloric density aerated confections. Optimal proportions of tagatose reduces the overall calorie content and crystallizes in dried marshmallow applications to provide an end product similar to short grained marshmallows as described in U.S. Pat. No. 4,251,561 issued Feb. 17, 1981 entitled “Low-moisture, Frangible Aerated Confections and Method of Preparation”. Tagatose also has a very low hygroscopicity which is a benefit to product handling in dried marshmallow applications.

Low caloric density aerated confections can comprise an effective amount of a heat tolerant high potency sweetener such as potassium acesulfame, sucralose or mixtures thereof. Use of such high potency sweeteners is often desired to enhance product sweetness, as previously mentioned tagatose has a sweetness potency 92% that of sucrose. Sucralose is preferred for use herein since acesulfame K (colloquially, “Ace K”) can impart a bitter taste to some consumers sensitive to potassium. Alitame, neotame, saccharin and cyclamates can also be employed but price, availability, consumer acceptance and governmental regulations all effect their selection for use. Thaumatin can also be used and provides the advantage of flavor masking off flavors. Also useful herein are trehelose, taglatose and mixtures thereof.

In less preferred variations, the products can employ supplemental “natural” or plant sweeteners such stevioside such as from ground stevia leaf, stevia extract (an herb, Stevia rebaudian, native to Peru and Paraguay) or essence or tincture of Rubus suavissimus. Such products are used at amounts effective to provide desired sweetness levels. Other sweetness enhancers and derivatives of that can be used include; glycyrrhizin, neohesperidine dihydrochalcone, mogroside, monellin, mabinlin, pentadin, brazzein, and curculin. Such materials are often blended with or formed into powder form by mixing with a solid substrate or carrier such as a starch or maltodextrin. While not temperature stable per se, the sweeteners can be added at levels that compensate for losses during processing. In preferred embodiments, such materials are added to cooled syrups so as to minimize any loss due to exposure to elevated temperatures. Generally, such products are used at levels ranging from about 0.001% to about 1% depending upon sweetening power of the active ingredient and concentration of the active ingredient in the sweetener ingredient. Preferred for use are sucralose, acesulfame, and mixtures thereof since such sweeteners are more tolerant of the manufacturing process than the plant derived sweeteners.

An alternative embodiment of this invention includes “quickly” and “slowly” dissolving low caloric density aerated confections each created by independent formulations, but often combined in a single marbit piece. By “quickly dissolving” herein is meant that a 0.2 g piece (whether spherical, cylindrical, or cube shaped) dissolves in liquid water or in a dairy beverage such as cold milk at a temperature above freezing up to 65° C. in about 10 to under 120 seconds. Better products dissolve in cold milk (5° C.) in about 20-90 seconds. If the low caloric density confectionery product dissolves too quickly (i.e., in 5 to less than 10 seconds), then the product is “instantly dissolvable”. If the low caloric density confectionery product dissolves more slowly, (i.e., in about greater than 120 seconds), then the product is “slowly dissolvable”. Slowly dissolvable products include low caloric density dried aerated marshmallow compositions that become soft upon extended exposure to cold milk (e.g., over 120 seconds) and dissolve thereafter only very slowly. Both instantly dissolvable and slowly dissolvable products are unsuitable for use herein as the principal essential product component although each component can be used alone or together as an optional additional component or portion.

It will be appreciated that the sugar profiles of such compositions can be similar. However, such alternative quickly dissolving low caloric density aerated confections substitute other ingredients for the common gelatin whipping/structuring agent to provide such tailored properties and utilize as their whipping agent either a non proteinaceous whipping agent (described herein) or a protein based whipping agent as described in U.S. Pat. No. 6,207,216. The non proteinaceous whipping agent is essential to providing the quick dissolving feature described herein as well as to provide a hypoallergenic version of the low caloric density quickly dissolving confection compositions. Suitable non proteinaceous whipping agents are selected from the group consisting of sodium lauryl sulfate (“SLS”), sodium steroyl lactylate (“SSL”), methyl cellulose (“MC”), hydroxypropyl methyl cellulose (“HPMC”), and mixtures thereof. Both SSL and SLS are well known food surfactants. Both methyl cellulose and hydroxypropyl of various types and grades are available from the Dow Chemical Company. While not wishing to be bound to the proposed theory, it is speculated herein that these particular foaming ingredients interfere with the structuring agent in a manner such that within the ranges for whipping ingredients and structuring agents herein, compositions can be provided that exhibit the rapid or quick dissolving feature desired herein.

Generally, in the production of such substituted methyl cellulose ethers, alkali cellulose is reacted with methyl chloride alone or in combination with propylene oxide to add substitute groups. Various specific chemistry groups are labeled as “A”, “E”, “F”, and “K” groups. Also, the initial high molecular weight alkali cellulose can be subjected to controlled degradation to produce various lower molecular weight materials. Generally, as the average molecular weight is reduced, so is the viscosity at standardized concentrations. Thus, the viscosity characterization for a particular grade and chemistry material is related to its average molecular weight. Higher numbers generally indicate higher viscosity, e.g. Methocel A15 will have a higher viscosity than Methocel A3.

Also, generally as greater amounts and/or higher strength structuring agents are employed, the higher viscosity MC and HPMC materials foaming agents become less effective at providing low caloric density quickly dissolving dried confections and the lower molecular weight or viscosity grades are preferred. Of course, formulating useful low caloric density quickly dissolving confection compositions requires some balancing of amount and strength of the structuring agent with selection of particular types and concentrations of foaming ingredient.

Useful materials include those grades of methyl cellulose and HPMC that are characterized by a viscosity of 3 to 450 centipoise (cps) across the various chemistries. Such useful materials specifically include, for example, those materials available under the trade designations as Methocel E3, F3, K3, E50, F50, F450, K100, and mixtures thereof. Preferred for use herein are low viscosity or lowest molecular weight varieties across the various substitution chemistries, e.g., characterized by a viscosity value of 3-50 cps and include the specific materials designated as Methocel grades E3, F3, K3, E50, F450, K100 and mixtures thereof. Most preferred for use herein for the hydroxypropyl methyl cellulose is that available under the trade name Methocel E3. Preferred for use herein is a combination of about 0.5% Methocel E3 with about 0.05% SLS especially when used in combination with gelatin as the structuring ingredient.

The skilled artisan will appreciate that these particular foaming agents are to be distinguished from other gum or thickening ingredients such as microcrystalline cellulose or carboxymethylcellulose.

The low caloric density food product compositions and products prepared therefrom can further comprise a wide variety of supplemental materials to improve the organoleptic, visual, and/or nutritional properties of the finished confectionery products. Useful materials include, for example, colors, flavors, preservatives, nutritional fortifying ingredients and mixtures thereof. If present, such optional materials can collectively comprise from about 0.01% to about 25% by weight of the present products, preferably about 1%-10%.

More preferably, any insoluble component such as a mineral fortifying ingredient (e.g. calcium carbonate or a calcium phosphate salt for calcium fortification) is added in the form of a fine powder having a particle size such that 90% has a particle size of less than 150 micron, preferably 100 μm or less in size and for best results under 10 microns.

In highly preferred embodiments, the low caloric density aerated grained confectionary products comprise a calcium ingredient of defined particle size in an amount effective to provide the desired calcium enrichment. As established, low caloric density aerated grained confectionary products find particular suitability for use as inclusions to child oriented ready-to-eat cereal products. Children are in particular need of additional calcium. Good results are obtained when the present low caloric density aerated confectionery compositions comprise sufficient amounts of calcium ingredients to provide a calcium content of about 50-2500 mg per 28.4 g (1 oz) serving (dry basis) (i.e., about 0.15%-10% by weight, dry basis) of calcium, preferably about 100-1500 mg Ca per 28.4 g (1 oz.), and more preferably about 200-1500 mg calcium/oz. Additionally, such nutritionally fortified products being sweet, being both quickly dissolving and crunchy are also well received by the elderly especially the very aged who need special nutritional care and who can be fussy about food.

Useful herein to supply the desired calcium levels are calcium ingredients that supply at least 20% calcium. Preferred for use herein are calcium ingredients selected from the group consisting of food grade calcium carbonate, ground limestone, calcium phosphate salts and mixtures thereof.

In one preferred embodiment, the improved low caloric density aerated grained confection compositions are fat free, i.e., have fat contents of less than 5%, preferably less than 0.5%. Low or no fat products are preferred for use herein since fats provide 9 kilocalories per gram. Such products are more easily able to be formulated to form the present low caloric density aerated grained confectionary products, when low or no fat ingredients are used. However, in these embodiments the fat level is provided by lipid content associated with one or more ingredients as compared to addition of a fat component. For example, when dry malted milk is used as a whipping agent, such as in the alternative embodiment of quickly dissolving low caloric density aerated grained confections, the high fat content of the malted milk (about 20%) can raise the total fat content. In other variations, e.g., chocolates, the aerated confection can comprise about 1%-25% of an added fat component homogeneously blended with the other components preferably about 1-10% such as cocoa butter, dairy fat or dairy fat containing (e.g., cheese) or other edible fatty triglyceride or fat mimics such as sucrose polyesters.

The low caloric density aerated grained confectionary compositions can be optionally flavored and/or colored to provide uniform products or products having phases of variously colored and flavored portions. By “color” is meant a confection of any color, including white, which may be provided by the base confection ingredients, and by additional artificial or natural coloring agents. “Color” also includes various hues or shades, e.g., pink and red.

While the present invention contemplates soft or compressible or higher moisture marshmallow products, the present invention finds particular suitability for use to provide low caloric density aerated grained confectionary compositions that are preferably dried to form dried frangible non-compressible shelf stable compositions having a reduced or residual moisture content ranging from about 1%-6%, preferably about 1%-3% and most preferably about 1%-2.5%.

The low caloric density confections' compositions have densities of 0.10-1.0 g/cc, preferably about 0.1-0.4 g/cc and most preferably about 0.15-0.3 g/cc. Preferred products have a density of about 0.1-0.4 g/cc at moisture contents of 1%-6%, preferably 2%-5%.

The present improved low caloric density aerated grained confectionery compositions can be formed into products such as suitably shaped and sized pieces. In preferred embodiments, the pieces have a size count ranging from about 0.2-6/g, preferably about 1-6/g, and most preferably about 3-6/g. Thus, pieces can range from about 0.15-5 g each. As a result, these pieces generally have a bulk density of about 235-340 g per liter. The pieces can be in common geometrical shapes such as disks, spheres, cylinders, cubes, or shaped such as to form three-dimensional shapes. The pieces can also be in the form of wafers (e.g., having a thickness of about 1-30 mm preferably about 2-15 mm) that can have a peripheral outline of a regular shape, e.g., pentagon or animal or can be randomly shaped. In preferred form, wafers can have a cross sectional area ranging from about 15 mm² to about 900 mm². Due to their relative thinness, such wafer shaped pieces are sometimes referred to as two dimensional shapes. While particular attention is paid herein to grained or crunchy finished products, the skilled artisan will appreciate that with modest formulation adjustments, particularly to the structuring ingredient, that non-grained, e.g., chewy, embodiments can easily be prepared.

In alternative embodiments, the pieces are in the form of composite pieces that additionally comprise a slowly dissolving aerated confection portion. The slowly dissolving portion is a portion that requires more than 90 seconds to dissolve in cold milk, preferably more slowly than two minutes. The slowly dissolving portion can be fabricated from known aerated confection compositions and techniques including those described in U.S. Pat. No. 6,207,216. Generally, such compositions comprise gelatin as the whipping ingredient as well as the structuring ingredient. Also, such slowly dissolving confection compositions generally do not include non-gelatin proteinaceous whipping or foaming ingredients nor the protein based whipping agents of the '216 patent.

The slowly dissolving portion to quickly dissolving portion can range widely from about 1:20 to about 20:1. Each portion(s) can be continuous or discontinuous. For example, one product can comprise both a core portion and also an outer shell portion. In a preferred variation, the low caloric density quickly dissolving portion comprises the outermost layer or portion with the core fabricated from a low caloric density slowly dissolving composition. In more preferred embodiments, the low caloric density quickly dissolving external portion completely surrounds the low caloric density slowly dissolving portion to form a shell. In a preferred form, the shell is in the form of an egg. Disposed within the egg or eggshell is the more slowly dissolving portion. This slowly dissolving portion can be formed into the shape of a small baby animal such as a duckling, chick, reptile, and dinosaur. Upon addition to cold milk, the egg portion quickly dissolves to reveal the contained shaped baby portion.

In another variation, the pieces can be fabricated in the form of shaped wafers, e.g., having an outline in the form of a familiar object. Such familiar objects can include a hat, star, moon, clover, diamond or heart. An example of a hat shape used to create a two component confection is well known and described in US D376,039 (issued Dec. 3, 1996). Such designs include an outer or peripheral layer fabricated from a low caloric density slowly dissolving aerated confection composition framing an inner quickly dissolving low caloric density core. The core by definition is typically smaller and centered within the larger design and may have a similar or very dissimilar shape. Upon addition to milk, the quickly dissolving low caloric density core portion “melts” away to reveal a shaped aperture. It would therefore be possible to have a low caloric density hat shaped aerated confection reveal a shamrock shaped aperture upon addition to cold milk. In other variations, the slowly and quickly dissolving low caloric density aerated confections can be reversed so that a hat shaped wafer dissolves quickly away to form a residual shamrock shaped wafer piece. In still other variations either portion can be discontinuous. For example, a clown face shaped piece with blue eyes, a red nose and a yellow mouth can be formed each from a low caloric density quickly dissolving portion that can each dissolve at the same or different rates but at a faster rate than the face portion.

While soft higher moisture variations require packaging in food packaging having moisture barrier properties and enjoy only limited shelf life, dried embodiments (i.e., having a moisture content of about 2%-5%) enjoy extended room temperature shelf life. Tagatose containing marbits because of their low hygroscopicity are particularly suited for dried embodiments, as they naturally resist absorbing atmospheric moisture. This is particularly useful when producing marbits in high humidity conditions experienced by certain geographic locations in the summer months of the United States. Traditional dried marbits tend to become sticky in high humidity conditions and adhere to one another and manufacturing equipment which make processing in a high speed manufacturing plant difficult. Tagatose containing marbits are less effected by natural humidity and therefore are less prone to sticking to one another or fouling manufacturing equipment.

The present tagatose containing dried product embodiments have similar break strength when compared to otherwise similar full calorie equivalents. Desirably, having similar strength can lead to no more abrasive loss during production handling of the finished dried product than would be expected of similar full sugar equivalents.

Also, the low caloric density tagatose products surprisingly exhibit comparable crunch and chew properties notwithstanding the difference in calorie content. Importantly, their bowl life in milk (as a component of a RTE cereal blend is also comparable to full calorie counterparts.

### Method of Preparation

The invention further provides processes for making the above described low caloric density aerated confections and products. The process essentially includes adding or admixing tagatose and optionally a nutritive carbohydrate component and fiber (if applicable). Heating the mixture to create a concentrated slurry, then reducing the temperature of the slurry sufficient to add a structuring agent. Other minor ingredients such as color, flavor, nonnutritive or artificial sweeteners or nutritional fortifying ingredients or combinations thereof may additionally be admixed. The slurry is aerated to achieve a desired density and extruded into ropes. The ropes are cooled and subsequently cut into pieces of a desired shape and size and dried. To reduce the stickiness of extruded ropes and/or pieces, a light coating of starch may be applied to either or both the ropes and pieces prior to the drying step.

More specifically, the present method to create a low caloric density aerated confection comprises a first step of creating a hot tagatose slurry. The hot tagatose slurry needed to create low caloric density aerated confections comprises about 75%-85% tagatose and about 15%-25% water. The hot tagatose slurry can optionally be prepared by replacing up to 60% of the tagatose with a nutritive carbohydrate component. The hot tagatose slurry can also be prepared replacing up to 25% of the tagatose with fiber. In the preferred embodiment, the combination of tagatose and nutritive carbohydrate component as a combined percentage of the total formula should remain superior to the fiber ingredient. To create the hot tagatose slurry the tagatose, water and optionally a nutritive carbohydrate component and fiber, if applicable are heated to melt the dry crystalline ingredients and concentrate the slurry. The dry crystalline ingredients should melt when the slurry is in the range of 87-133° C. (190-270° F.), preferably between 93-122° C. (200-250° F.) and most preferably between 101-113° C. (215-235° F.). A conventional steam-jacketed kettle and an electric or pneumatic mixer or a common food application steam heated screw conveyor can be used to mix and heat the slurry. Those skilled in the art can appreciate that any heating and mixing system, including a single unit operation system such as a twin screw extruder, can be used to create a hot tagatose slurry. The mixing and heating step can include a further sub-step of boiling or concentrating the tagatose, optional nutritive carbohydrate component, optional fiber component and water mixture to form a concentrated hot tagatose syrup having a moisture ranging from about 10%-15%.

To prepare the hot tagatose slurry for the addition of hydrated gelatin, the hot tagatose slurry is cooled to 60-83° C. (140-180° F.), preferably between 65-77° C. (150 and 170° F.) and most preferred 68-74° C. (155-165° F.) to form a cooled concentrated tagatose slurry.

The cooled concentrated tagatose slurry can optionally be seeded with about 1% crystalline material to form a seeded cooled concentrated tagatose slurry. Seeding is optionally performed to accelerate the formation of crystals in the cooled slurry, important if a grained crunchy confection is desired.

Cooling the hot tagatose slurry is accomplished by reducing the heat source while continuing the mixing process. Regardless of the technique, the hot tagatose slurry is cooled prior to addition of the hydrated gelatin. Many foam structuring agents such as gelatin exhibit degradation and loss of their foam structuring properties when subjected to higher temperatures such as those in a hot tagatose slurry. Still another problem is that gelatin, in the presence of reducing sugars can produce undesirable Maillard reaction browning.

Hydrated gelatin as described herein is a mixture of gelatin and water preferably in the range of 1 part gelatin to 2.5 parts water to 1 part gelatin to 5 parts water, most preferred 1 part gelatin to 3 parts water. Hydrated gelatin is traditionally created by mixing gelatin and cold water, preferably less than 27° C. (80° F.), in the above mentioned ratios. Hydration typically occurs in 15-60 minutes. Hydrated gelatin is traditionally heated between 65-100° C. (150-212° F.) to create a gelatin melt, suitable for addition to the cooled concentrated tagatose slurry, prior to aeration. One skilled in the art can appreciate that alternative gelatin hydration methods, alternative forms of gelatin and other suitable whipping agents (some described herein) exist and can all be applied to this method.

Aeration of the cooled concentrated tagatose slurry can be accomplished by any number of means well known to those skilled in the art. As described above the objective of aeration is to produce a foam with a density of 0.1-0.35 g/cc at atmospheric pressure. Aeration is accomplished by injecting a gas into the cooled concentrated tagatose slurry while whipping or other similar agitation of the slurry occurs. Since this is a food product the gas selected should be non-toxic and relatively inert. Suitable gasses include air, nitrogen and carbon dioxide. While air or other inert gasses can be employed, preferred for use herein as the aerating gas is nitrogen.

Equipment useful for aerating low caloric density confections are well known to persons skilled in the art. A full description of such useful equipment and techniques can be found in U.S. Pat. No. 2,600,569 issued Jun. 17, 1952. This patent describes the Oakes type continuous marshmallow whipper named after its inventor Earl T. Oakes. Since Oakes type aeration or other mechanical aeration can result in frictional heating of the foam so formed, aeration can be practiced with supplemental cooling before, during and/or immediately after the aeration step for better control of the foam temperature desirably within the range of 20-80° C., preferably about 50-60° C., to provide a warm plastic low caloric density confectionery foam.

In certain variations, the addition of different colors and flavors to individual portions or sub-streams is practiced by post aeration addition rather than pre-aeration. An advantage of post-aeration division and coloration is that only a single aerator is required. However, pre-aeration sub-division, while requiring multiple aerators also allows for greater control of end product attributes such as the degree of aeration and thus final product density.

After the aeration step, the aerated warm plastic low caloric density confectionery foams are extruded into one or more ropes. If desired, the peripheral shape of the rope can be selected to impart a desired shape to the finished products. For those products intended as dried low caloric density marshmallows, good results are obtained with rope thickness ranging from about 5-20 mm. In practice, the ropes are applied to a bed of cornstarch (alone or filled with other ingredients as described herein) since the warm plastic ropes are quite sticky. Often, additional cornstarch is topically applied to the sticky top surface of the rope. The dusting starch typically adds about 1%-10% starch (dry weight basis) to the confection composition typically proximate to the outer periphery of the ropes after de-starching. The dusting starch also facilitates sectioning the ropes into individual pieces by reducing the stickiness of the ropes.

The dusted ropes can be cooled to about ambient temperature 21-38° C. (70-100° F.) to allow the foam to set sufficiently for subsequently being cut into individual pieces of a desired shape and size and dried. Conveniently, the ropes are advanced along a moving belt to allow the structuring agent sufficient time to set to form ropes that can be sectioned into individual pieces without deforming the foam structure of the aerated composition. Good results are obtained when the ropes are allowed to cool for a minimum of 15-120 seconds to form the cooled solid aerated wet foams. Higher foam temperatures during extrusion can require longer cooling or setting times within this minimum range. Of course, once cooled for the minimum times to set the structure of the foam, the ropes can be allowed to cool longer or be held for extended times.

Thereafter, the cooled structure set ropes can then be cut or sectioned into individual pieces by suitable cutting means such as by employing a reciprocating guillotine knife or other slicer. In a preferred variation, a high speed rotary knife is employed such as is described in U.S. Pat. No. 6,251,203 “Method and Apparatus for Processing Aerated Confectionery Foam Rope” (issued Mar. 6, 2001 to Zietlow et al.). Preferred herein is to form thin wafers ranging from about 1 to 10 mm in thickness, preferably about 2-5 mm, although thicker products for soft marshmallow products are also contemplated, e.g., 20-40 mm.

Conveniently, the pieces so formed are put through a scalper to remove cornstarch from the pieces to provide de-starched pieces. The extra removed cornstarch can be captured and recirculated.

In the manufacture of traditional soft marshmallow or other soft confections, the products so prepared are finished and ready for conventional packaging for distribution and sale. Such products can have a moisture content ranging from about 10%-25%, preferably about 10%-15%.

However, in the preferred embodiment of preparation of a dried aerated confection such as the marbit, the present methods additionally comprise a step of finish drying the individual and de-starched pieces to about 2%-4% moisture. Any suitable drying technique which will reduce the moisture content to about 1%-4% is adequate. In one preferred technique, the marbits are dried at a slower rate using forced hot air convection drying. For example, the pieces can be put on trays, mounted in a frame that holds about 30-40 trays, and rolled into a drying room until adequately dried. The drying room is kept at a temperature of about 82° C. (180° F.). In other implementations, the pieces are transported by a conveyor through a drying room or tunnel until the desired moisture is reached. Extended forced hot air drying at cooler temperatures in trays can also be employed (for 2-24 hours). In another example, a suitable method is taught in U.S. Pat. No. 4,785,551 entitled “Method of Drying Confection Pieces”. The '551 patent teaches a rapid, five minute drying step using a two-step fluidized bed heating step.

The resulting dried pieces can then be consumed as low caloric density confections or added to conventional or reduced calorie Ready-to-Eat breakfast cereals. An advantage is that such confectionery products dissolve in the cold milk with which such RTE cereals are conventionally consumed.

In an alternative method aspect, someone skilled in the art can appreciate that low caloric density nutritionally fortified grained aerated confections can be created by applying the method taught in '953. The method taught in '953 describes a method of making nutritionally fortified aerated confections where dry particulate forms of nutritional fortifying ingredients are added to a confectionary slurry either alone or in combination with dry sugar crystals prior to aeration. In the case of the present invention the aforementioned confectionary slurry would necessarily be a tagatose confectionary slurry as taught herein. Similarly, the dry sugar crystals taught in '953 as useful for blending with dry particulate forms of nutritional fortifying ingredients can be substituted with dry tagatose crystals.

In yet another alternative method aspect, multi-colored low caloric density grained aerated confections can be created by applying the method taught in U.S. Pat. No. 6,309,686, Multi-colored Aerated Confectionery Products and Process For Making, issued Oct. 30, 2001. In '686, multi-colored confections are created by aerating a plurality of separate, individually colored marshmallow slurries just prior to the extrusion step. In the case of the present invention the aforementioned marshmallow slurries would be low in caloric density to create multi-colored versions of the low caloric density aerated confections taught herein.

In still another alternative method aspect, quickly dissolving low caloric density aerated confections can be created by applying the method taught in U.S. Pat. No. 6,207,216, Quickly Dissolving Aerated Confection and Method of Preparation, issued Mar. 27, 2001. In '216 composite products are prepared containing a first portion of a quickly dissolving aerated confection composition and a second slowly dissolving aerated confection portion. The method essentially involves combining without intermixing two independently prepared streams, one quickly and one slowly dissolving, and co-extruding the two streams to form a combined extrudate. The combined extrudate having at least two phases, one quickly and one slowly dissolving. In the case of the present invention the aforementioned quickly and slowly dissolving aerated confection compositions would have low caloric densities as taught herein.

A hypoallergenic version of low caloric density quickly dissolving aerated confections can also be produced. The hypoallergenic low caloric density composition methods of preparation comprise the steps of preparing a warm slurry comprising tagatose, optionally a nutritive carbohydrate component, optionally fiber, a hypoallergenic marshmallow structuring component, a non proteinaceous foaming agent and an excess of moisture; aerating the warm slurry with nitrogen to form a warm plastic low caloric density aerated marshmallow foam; forming the foam into pieces; and, drying the pieces to a dried moisture content of 2%-4% to form low caloric density quickly dissolving dried marshmallow pieces.

The hypoallergenic quickly dissolving low caloric density aerated confections can be created by first preparing a slurry comprising the sub-steps of:

admixing at least a portion of the tagatose with the non proteinaceous foaming agent to form a dry blend;

admixing the dry blend in at least a major portion of water to form a tagatose syrup;

admixing the balance of the tagatose and optional nutritive carbohydrate sweetening component to the syrup;

heating the syrup to dissolve the crystalline particulates to about 75-100° C. (170-212° F.) to form a hot clear tagatose syrup;

hydrating the hypoallergenic structuring agent in the balance of the moisture to form a hydrated hypoallergenic structuring agent;

cooling the hot clear tagatose syrup to a temperature of 72° C. or cooler to form a warm clear tagatose syrup;

admixing the hydrated hypoallergenic structuring agent with the warm tagatose syrup to form a warm slurry;

By these sub-steps, extended exposure of the hypoallergenic structuring agent to elevated temperatures is minimized. Such minimization of exposure to elevated temperatures is particularly important when all or a portion of the hypoallergenic structuring agent is supplied with a temperature sensitive ingredient. Alternatively, by dry blending the foaming agents in dry form with at least a portion of the tagatose, good dispersal of the foaming ingredients can be obtained. One skilled in the art would have little difficulty altering the method described in '216 and the method described herein with these changes to create hypoallergenic low caloric density quickly dissolving aerated confections.

Similar to non-hypoallergenic quickly dissolving low caloric density grained aerated confections, the hypoallergenic quickly dissolving low caloric density versions can also additionally include various other ingredients such as vitamins, colors and minerals or other nutritional or even pharmaceutical ingredients. Such ingredients can be added to the dry blend described above. Those additional ingredients selected for addition to hypoallergenic low caloric density quickly dissolving aerated confections should likewise be selected from those known to be hypoallergenic.

Optionally, the hypoallergenic low caloric density quickly dissolving methods can also comprise a step of adding tagatose crystals or sugar crystals to the warm tagatose syrup to form a crystal seeded warm slurry. Such crystal seeding of the slurry can be practiced for better control of desired end product properties (and as more fully described in U.S. Pat. No. 6,436,455 noted above).

Low caloric density aerated grained confectionery pieces, particularly dried marshmallow pieces; find particular suitability for use as an appealing added component of food products to reduce the overall calorie content. For example, the pieces may be admixed with a Ready-To-Eat breakfast cereal, especially reduced calorie R-T-E cereals, intended as children's breakfast cereals.

In a preferred embodiment, the finished RTE cereal can comprise about 60%-99% of a conventional or reduced calorie dried cereal (such as biscuits flakes, puffs, shreds, granola, and mixtures thereof, formed from a cooked cereal grain or dough of oats, wheat, corn, barley, rice or mixtures thereof) and about 1% to about 40% by weight of the present novel low caloric density dried marshmallow pieces. In still other variations, the present confections can be admixed with regular or reduced calorie versions of instant oatmeal, dry cocoa beverage mix (especially smaller sized pieces), and dry mixes for other products. The low caloric density confections can also be used in regular or reduced calorie versions of cereal bar products, toppings for reduced calorie ice cream or yogurt, or on various reduced calorie baked goods. The present compositions can also be used as an ingredient or phase of other composite confections or candy products.

In other variations, the confections provide appealing low calorie carriers for various pharmaceuticals whether containing over-the-counter medications or ethical or prescription drugs or, vitamins, minerals, nutraceuticals, micronutrients, macronutrients, phytosterols, dietary supplements, mixtures thereof and the like. Due to the aerated and frangible texture, the low calorie confections are easy to chew, especially the quickly dissolving versions. In preferred embodiments, such materials are likewise added to the cooled tagatose slurry before aeration. Addition at this step in the process of preparation minimizes any heat exposure that might degrade the potency or functionality of any such added active ingredient or minimize any unintended reaction or interaction between such components that might lead to undesired organoleptic properties.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An aerated food product, comprising:
about 88%-97% (dry weight basis) tagatose;
about 3%-12% (dry weight basis) of a structuring component; and,
said product aerated to a density of about 0.10 to 1 g/cc.

2. The aerated food product of claim 1 wherein up to about 50% of the tagatose is substituted with a saccharide component.

3. The aerated food product of claim 2 wherein the saccharide component is selected from the group consisting of sucrose, fructose, corn syrup, dextrin, maltose, dextrose, levulose and mixtures thereof.

4. The aerated food product of claim 1 wherein up to about 25% of the tagatose is substituted with fiber.

5. The aerated food product of claim 1 wherein the structuring component is selected from the group consisting of gelatin, pectin, starch, gums and mixtures thereof.

6. The aerated food product of claim 1 having a fat content of about 0.1%-15%.

7. The aerated food product of claim 1, additionally comprising:
about 0.1%-1.5% by weight of a member selected from the group consisting of flavors, dyes, coloring agents, preservatives and mixtures thereof.

8. The aerated food product of claim 1, additionally comprising:
about 1% or less of a high potency sweetener.

9. The aerated food product of claim 8 wherein the high potency sweetener is selected from the group consisting of aspartame, potassium acesulfame, sucralose and mixtures thereof.

10. The aerated food product of claim 1 having a moisture content of about 1%-6%.

11. The food product of claim 1, additionally comprising nutritional fortifying component.

12. The food product of claim 1 wherein the structuring component is methocel and additionally comprising about 0.1%-1% of a foaming agent.

13. The food product of claim 12 free of any soy protein.

14. The food product of claim 1 in the form of a blend additionally comprising about 65%-99% of a ready-to-eat cereal.

15. A method for preparing the aerated food product, comprising the steps of:
A. providing a hot slurry comprising:
about 35%-75% (dry weight basis) tagatose;
35% (dry weight basis) or less of saccharide components;
25% (dry weight basis) or less fiber;
10% (dry weight basis) or less structuring agents;
5% or less whipping or foaming agents;
20% or less moisture;
B. aerating the slurry to form an aerated foam having a density of about 0.25 g/cc. and a temperature of about 32-82° C. (90-180° F.);
C. extruding the aerated low caloric density foam at a temperature of about 32-82° C. (90-180° F.) to form an aerated low caloric density extrudate;
D. cooling the low caloric density extrudate to form a set aerated low caloric density extrudate; and,
E. forming the set aerated low caloric density extrudate into pieces.

16. The method of claim 15 wherein step A includes about 0.01%-15% (dry weight basis) of nutritional fortifying ingredient selected from the group consisting of biologically active components, micro-nutrients, minerals and mixtures thereof.

17. The method of claim 15 wherein step A includes about 0.1%-1.5% (dry weight basis) a member selected from the group consisting of flavors, dyes, coloring agents, preservatives and mixtures thereof.

18. The method of claim 15 wherein step A includes about 1% (dry weight basis) or less of a high potency sweetener selected from the group consisting of aspartame, potassium acesulfame, sucralose and mixtures thereof.

19. The method of claim 15 wherein step A the structuring component is selected from the group consisting of gelatin, pectin, starch, gums, methocel and mixtures thereof.

20. The method of claim 15 wherein step A the slurry has a fat content of less than 15%.

21. The method of claim 15 wherein step A and step B include the sub-steps of:
A.1. providing a second hot slurry comprising:
about 35%-75% (dry weight basis) tagatose;
35% (dry weight basis) or less of saccharide components;
25% (dry weight basis) or less fiber;
10% (dry weight basis) or less structuring agents;
5% or less whipping or foaming agents;
20% or less moisture;
B.1. aerating a second slurry to form an aerated foam having a density of about 0.25 g/cc. and a temperature of about 32-82° C. (90-180° F.);
B.2. feeding the first and second aerated foams into an extruder as a composite foam.

22. The method of claim 16 wherein step A and step B include the sub-steps of:
A.1. providing a second hot slurry comprising:
about 35%-75% (dry weight basis) tagatose;
35% (dry weight basis) or less of saccharide components;
25% (dry weight basis) or less fiber;
10% (dry weight basis) or less structuring agents;
5% or less whipping or foaming agents;
20% or less moisture;
about 0.01%-15% (dry weight basis) of nutritional fortifying ingredient selected from the group consisting of biologically active components, micro-nutrients, minerals and mixtures thereof;
B.1. aerating a second slurry to form an aerated foam having a density of about 0.25 g/cc. and a temperature of about 32-82° C. (90-180° F.);
B.2. feeding the first and second aerated foams into an extruder as a composite foam.

23. The method of claim 17 wherein step A and step B include the sub-steps of:
A.1. providing a second hot slurry comprising:
about 35%-75% (dry weight basis) tagatose;
35% (dry weight basis) or less of saccharide components;
25% (dry weight basis) or less fiber;
10% (dry weight basis) or less structuring agents;
5% or less whipping or foaming agents;
20% or less moisture;
about 0.1%-1.5% (dry weight basis) a member selected from the group consisting of flavors, dyes, coloring agents, preservatives and mixtures thereof;
B.1. aerating a second slurry to form an aerated foam having a density of about 0.25 g/cc. and a temperature of about 32-82° C. (90 to 180° F.);
B.2. feeding the first and second aerated foams into an extruder as a composite foam.

24. The method of claim 18 wherein step A and step B include the sub-steps of:
A.1. providing a second hot slurry comprising:
about 35%-75% (dry weight basis) tagatose;
35% (dry weight basis) or less of saccharide components;
25% (dry weight basis) or less fiber;
10% (dry weight basis) or less structuring agents;
5% or less whipping or foaming agents;
20% or less moisture;
about 1% (dry weight basis) or less of a high potency sweetener selected from the group consisting of aspartame, potassium acesulfame, sucralose and mixtures thereof;
B.1. aerating a second slurry to form an aerated foam having a density of about 0.25 g/cc. and a temperature of about 32-82° C. (90 to 180° F.);
B.2. feeding the first and second aerated foams into an extruder as a composite foam.

25. The method of claim 19 wherein step A and step B include the sub-steps of:
A.1. providing a second hot slurry comprising:
about 35%-75% (dry weight basis) tagatose;
35% (dry weight basis) or less of saccharide components;
25% (dry weight basis) or less fiber;
10% (dry weight basis) or less structuring agents selected from the group consisting of gelatin, pectin, starch, gums, methocel and mixtures thereof;
5% or less whipping or foaming agents;
20% or less moisture;
about 1% (dry weight basis) or less of a high potency sweetener selected from the group consisting of aspartame, potassium acesulfame, sucralose and mixtures thereof;
B.1. aerating a second slurry to form an aerated foam having a density of about 0.25 g/cc. and a temperature of about 32-82° C. (90-180° F.);
B.2. feeding the first and second aerated foams into an extruder as a composite foam.
